(19) United States
(12) Patent Application Publication
(10) Pub. No.: US 2018/0033100 A1
(43) Pub. Date: Feb. 1, 2018

(54) Real Estate Floor Plan System

(71) Applicants: Joanne Marie Rosen, Nanaimo (CA); Mark Jeffrey Rosen, Nanaimo (CA)

(72) Inventors: Joanne Marie Rosen, Nanaimo (CA); Mark Jeffrey Rosen, Nanaimo (CA)

(21) Appl. No.: 14/816,475

(22) Filed: Aug. 3, 2015

Related U.S. Application Data
(60) Provisional application No. 62/032,594, filed on Aug. 3, 2014.

(51) Int. Cl. G06Q 50/16; A47G 27/02

(52) U.S. Cl. CPC G06Q 50/16; A47G 27/0243

(57) ABSTRACT

The invention, Real Estate Floor Plan System, is a series of pre-cut shapes printed on flexible vinyl, which can be rolled, placed and carried in a lightweight, tubular shoulder bag.

This new product will be marketed towards realtors, interior designers, DIYers, moving companies, or anyone who deals with vacant rooms or properties.

Real Estate Floor Plan System is designed to a help clients visualize and plan how their furniture will best fit in specific spaces inside a home, office, or business.

### BACKGROUND

Spatial recognition, being able to visualize how items will fit within a specific space, is difficult for most people. When faced with an empty room, even a seasoned Realtor may not realize what will actually fit. The same can happen with interior designers, stagers, or relocation specialists from moving companies.

Realtors, for example, use many methods to try to demonstrate furniture sizes. They may pace out the size of the furniture, or hold their arms out to the side to approximate the size. Others use a tape measure or sketches on paper. Of course, there are also high tech solutions but those don't provide the spatial interaction needed to test functionality of the design.

### SUMMARY OF THE INVENTION

Real Estate Floor Plan System was created to fill these needs. This new and unique product solves a problem for realtors, designers, DIYers, interior designers and moving companies. It fills the void between staged homes and other, less effective, methods of showing vacant property. It allows families to plan where their furniture will be placed before the movers arrive. It allows designers and contractors to show the potential of a previously underused space like a basement or attic.

It is a series of pre-cut multifunctional shapes that represent the industry-standard home or office furnishings. The pieces are made of durable, flexible, washable vinyl that has been imprinted with colors and words specific to each piece. When not in use, they can be easily rolled, placed, and transported inside a lightweight carry bag.

### DETAILED DESCRIPTION

Real Estate Floor Plan System is a series of shapes that represent the size of home or office furnishing. These shapes and sizes conform to the standard industry sizes for specific items such as tables and chairs. As well, there is an expansion pack including desks, extensions, office chairs, file storage etc.

Each piece is pre-cut, marked and labeled and made from durable, flexible, washable vinyl imprinted with colors and words specific to each piece. The vinyl weighs 150-300 grams per square meter dependent on the needs of the client. The vinyl shapes can easily be rolled and placed inside a nylon carry bag.

### Features:

It is:

Easy to use—labels make placement simple
Durable—made of lightweight vinyl
Washable—fingerprints and smudges can be easily removed
Portable—rolled up and carried in a lightweight carrying case
Strong—resistant to tears unlike paper products
Functional—allows clients to place and move the shapes around the space
Flexible—easy to roll, fold, or bend, and quickly lays flat
Cost effective—will last for years
Colourful—clients can see how different colours will look in the space, also allows them to easily be seen against any floor surface
Sized to industry standards—clients will know that their furniture will fit

### DESCRIPTION OF USE

When a client is viewing a property, they will often wonder if their furniture will fit into the rooms. This is a “buying signal” for Realtors and demonstrates a client's interest in the property. Designers can show a computer model but clients may still not understand the spatial function. Movers often guarantee that they will move the furniture until the client is satisfied.

Using the example of the Realtor, at that point they can simply slide the pieces from the tube and unroll the Real Estate Floor Plan System. The various vinyl pieces will be displayed for the client to choose.

For example, if the client wants to see how their child's twin bed will fit in the room, they choose the piece marked “Twin Bed” (FIG. 2) and position it inside the space. They can see how it fits in one place but also move it around for other configurations of the room.

In another room, they may want a King or Queen bed. They simply place the two pieces (FIGS. 1 & 2) beside one another for a King, or slide the second piece to the marking on FIG. 1 for a Queen.

This same procedure is followed for whatever furnishings they would want in the space and allows the clients to arrange shapes individually or to fill the entire room with a complete set of furnishings to represent a bedroom set, living room suite, dining set etc. They can even take pictures for the movers.

Once the client is finished, the user rolls the shapes around the cardboard tube and places them back inside the carrying bag.

### DESCRIPTION OF DRAWINGS

FIG. 1. Twin Bed or Double/Queen/King bed (when used with FIG. 2), or a 2-person sofa (sized and labeled in English, Spanish and Chinese)

FIG. 2. Twin Bed or Dining Table (rectangular or oval), or 3-person sofa (sized and labeled in English, Spanish and Chinese)

FIG. 3. Dresser or sofa extension (sized and labeled in English, Spanish and Chinese)

FIG. 4. Dining chair or Nightstand (sized and labeled in English, Spanish and Chinese)

FIG. 5. Three drawer dresser or Entertainment center (sized and labeled in English, Spanish and Chinese)

FIG. 6. Coffee table or Shelf unit (sized and labeled in English, Spanish and Chinese)

FIG. 8. Bookcase (sized and labeled in English, Spanish and Chinese)

FIG. 9. Nylon carry bag 110 cm×11 cm diameter

A commercial office set is as shown in FIGS. 11-18. This is an expansion pack that allows for commercial design including offices, reception areas, and file areas. It can also be used on a standalone basis for simple office layouts or for creating a home workspace.

FIG. 11. Manager's desk (sized and labeled in English, Spanish and Chinese)

FIG. 12. Assistant's desk (sized and labeled in English, Spanish and Chinese)

FIG. 13. Desk extension (sized and labeled in English, Spanish and Chinese)

FIG. 14. Manager's chair (sized and labeled in English, Spanish and Chinese)

FIG. 15. Assistant's chair (sized and labeled in English, Spanish and Chinese)

FIG. 16. Credenza/horizontal file storage (sized and labeled in English, Spanish and Chinese)

FIG. 17. Vertical drawer file cabinet (sized and labeled in English, Spanish and Chinese)

FIG. 18. Cubicle partition (sized and labeled in English, Spanish and Chinese)

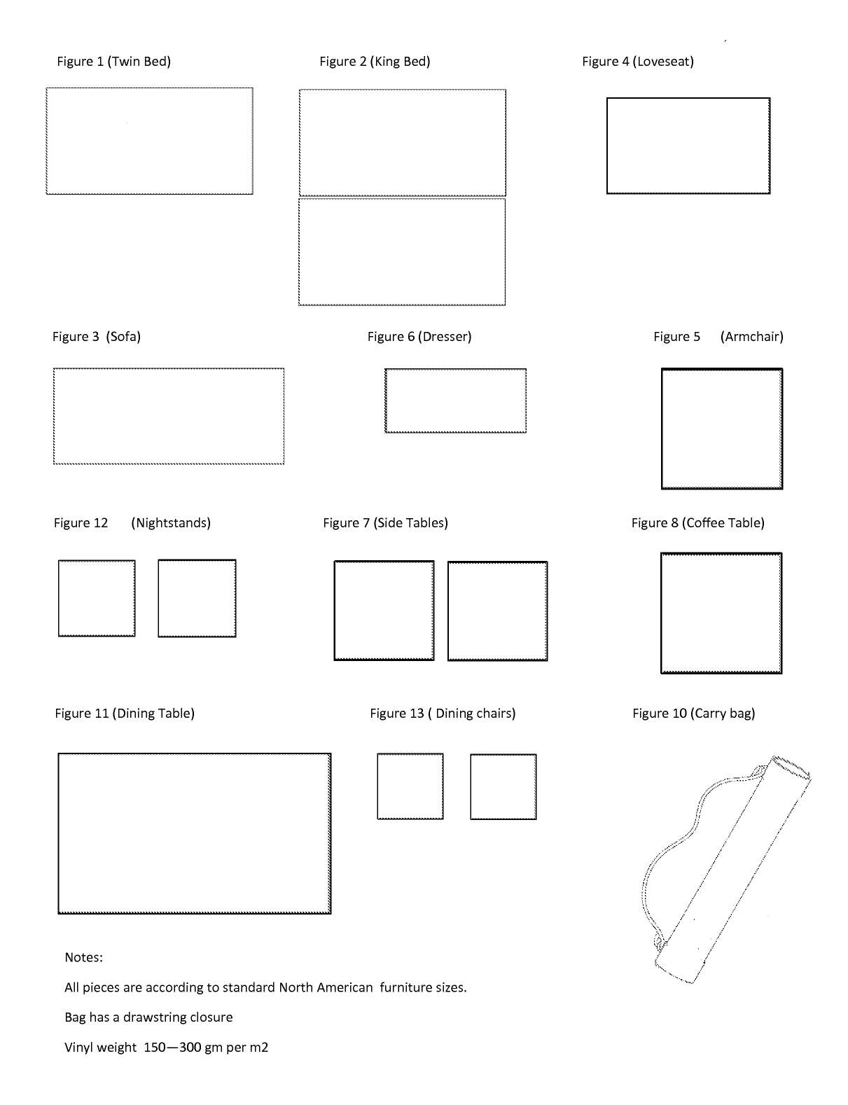

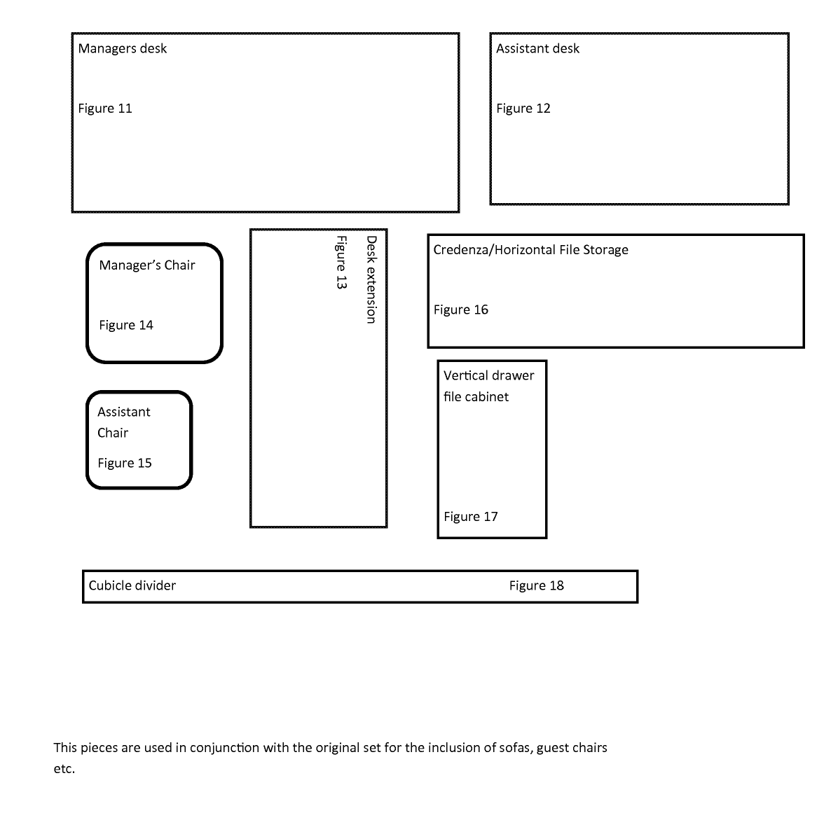

1. As mentioned in the Background section of this application, there are full-size furniture templates on the market. However, they are made of paper or cardboard. They are in a dull white or tan colour with black lines indicating different furniture sizes. They are designed for single use by homeowners and are not durable, washable, or easily portable.
This new product, Real Estate Floor Plan System, is unique—it is targeted towards realtors, interior designers, DIYers, leasing agents, and moving companies for repeated use by their clients.
There is no other product on the market that includes all of the features and benefits listed below.
Real Estate Floor Plan System is an innovative system that solves problems for relocation professionals and their clients in a new way.
It is:
durable—made of lightweight vinyl
washable—fingerprints and smudges can be removed
portable—rolled up and carried in a lightweight carrying case
strong—resistant to tears like paper products
functional—allows clients to place and move the shapes around the space
flexible—easy to roll, fold, or bend—quickly lays flat to original shape
cost effective—will last for years
colourful—clients can see how different colours will be in the space
sized to industry standards—clients will know that their furniture fits
